(19) United States
(12) Patent Application Publication
(10) Pub. No.: US 2008/0250418 A1
(43) Pub. Date: Oct. 9, 2008

(54) HEALTH CARE ADMINISTRATION SYSTEM

(76) Inventor: Murali M. Karamchedu, Beaverton, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/028,626

(22) Filed: Feb. 8, 2008

Related U.S. Application Data
(60) Provisional application No. 60/888,855, filed on Feb. 8, 2007.

(51) Int. Cl. G06F 9/50

(52) U.S. Cl. 718/104

(57) ABSTRACT

Embodiments of the present invention provide systems and methods for managing an event in a health care organization, the method comprising standardizing, during a design phase, a workflow associated with an event; and executing, during an executing phase, the workflow to complete a procedure associated with the event. Other embodiments may be described and claimed.

### CROSS REFERENCE TO RELATED APPLICATIONS

The present application claims priority to U.S. Provisional Patent Application No. 60/888,855, filed Feb. 8, 2007, entitled “HEALTH CARE PLAN ADMINISTRATION SYSTEM INCLUDING PROCEDURES, ACTIVITIES AND/OR FORM MANAGEMENT,” the entire disclosure of which is hereby incorporated by reference in its entirety.

### TECHNICAL FIELD

Embodiments of the present invention relate to the field of health care, and more particularly, to methods and systems for health care administration system.

### BACKGROUND

There are numerous doctors and health care organizations that provide different types of health care services to individuals. As there are numerous doctors and health care organizations, there are also numerous types of health insurance providers. The insurance coverage may include reimbursement for whole or partial costs associated with health care services.

Because of the numerous types of physicians, health care organizations, insurance coverages, insurance providers, as well as the numerous types of health care related services, it may be difficult to manage an efficient health care administration system.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is an exemplary block diagram illustrating a health care administration system that may be employed in a health care organization in accordance with various embodiments of the present invention.

FIG. 2 is an exemplary flow diagram illustrating a method for a design phase of the system of FIG. 1 in accordance with various embodiments of the invention.

FIG. 3 is an exemplary flow diagram illustrating a method for an execution phase of the system of FIG. 1 in accordance with various embodiments of the invention.

FIG. 4 is an exemplary block diagram illustrating a computer system that may be suitable for practicing a health care administration system in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A and/or B” means “(A), (B), or (A and B)”. For the purposes of the present invention, the phrase “A/B” means “(A), (B), or (A and B),” similar to the phrase “A and/or B”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Various embodiments of the present invention will be described herein with respect to generating, maintaining, and managing a health care administration system. However, those skilled in the art will understand that the present invention may be applicable to generating, maintaining, and managing an administration system with respect to other areas as well.

A health care organization may provide numerous health related services and may charge the patient and/or her insurance company for the services provided. The health care organization may be engaged in contractual obligation with numerous health insurance companies. Additionally, the health care organization may have contracts with several other organizations and individuals, e.g., physicians, specialists, other healthcare professionals, laboratories, etc. The health care organization may include various departments, e.g., billing, contracting, service providing, human resource, etc. Additionally several health care service providers may operate under a health care network or a health plan, and may need to share various types of information. Accordingly, various health care entities (e.g., departments within a health care organization, various health care service providers within a health care network, various health care organizations, etc.) may have to communicate and share between them numerous types of information.

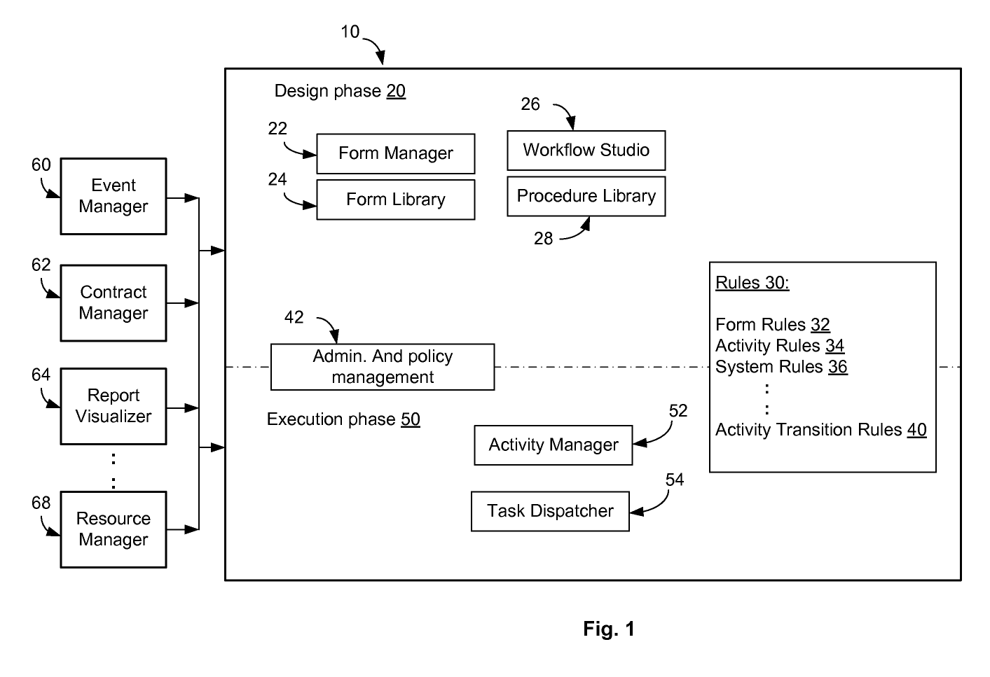

FIG. 1 is an exemplary block diagram illustrating a health care administration system 10 that may be employed in a health care organization in accordance with various embodiments of the present invention. In various embodiments, the system 10 may operate in a design phase 20 and/or an execution phase 50. In the figure, some of the components of the system 10 are shown under the respective phases for which the components are mainly used (e.g., form manager 22 is illustrated under design phase 20), while some components are shown to be common in both of the phases. As would be readily appreciated by those skilled in the art, the grouping of the components in two phases is done for illustrative purpose, and in various embodiments, the system 10, or its various components, may not be physically grouped. Also, as would be understood by those skilled in the art, in various embodiments, components illustrated in one of the phases may be used in the other phase as well.

Referring to FIG. 1, the design phase 20 includes a form manager 22, which may be used to generate, design, maintain, and/or manage various forms used in the health care organization. In various embodiments of the present invention, the term “form” may broadly refer to any format used to store, maintain, and/or communicate data. For example, if the health care organization enters into a contract with a laboratory that may provide service to the health care organization, the organization may fill several types of forms, including, for example, terms and rates of the contract, details of the laboratory, financial and legal information, etc. In various embodiments, a form may be digitally generated, maintained, and managed.

In various embodiments, a form may be composed of several form elements (e.g., various form fields, form values in the form fields, etc.). In various embodiments, a form may be delineated into different sections. A form may be saved with defined form fields and/or attributes such as name, timestamp, author etc. and made available for general use whenever necessary. In various embodiments, the system 10 may include a form library 24 where some or all the forms may be saved for later use. A user of the system 10 may, during the design phase 20, create a form using the form manager 22.

In various embodiments, the term “form action” may broadly refer to an act of changing a value of form field(s) (e.g., changing a patient's name in a form) and/or form attribute(s) by a user of the system 10. In various embodiments, the term “form instruction” may broadly refer to an act of automatically dealing with value(s) of form field(s) and/or form attribute(s) by the system 10 in response to one or more “form condition(s)”. For example, a form instruction may change a value of a form filed and/or set a range that a value of a form field may take. In various embodiments, the term “form condition” may broadly refer to checking a condition associated with a form value (e.g., whether a form value, say, a patient's year of birth, is equal to or greater than a threshold, say 1967) of a form field, based on which a “form instruction” may be issued. In various embodiments, a form condition may be nested or grouped. A form condition may be comparison based (e.g., comparing a form value with a threshold), existence based (if a form value exists), etc.

In various embodiments, the term “activity” may broadly refer to a user of the system 10 (user activity) or the system itself (system activity or system action), either manually or automatically, performing an act resulting in a change in the system. Examples of activities include, for example, a change in a form field (including, but not limiting to, adding, modifying, deleting, a form value in the form field), a change in the status of a component of the system (e.g., a condition that declares that another activity has completed, a condition that declares that another activity has not completed), etc.

In various embodiments, the term “procedure” may broadly refer to a sequence of activities, where one activity may become relevant after completion of the previous activity. In various embodiments, an “event”, which may be associated with the first activity in the sequence of activities, may trigger a procedure.

In various embodiments, the term “event” may broadly refer to significant changes in the system, which is different from merely changing a form value or a form field. For example, when the health care organization enters into a contract with another individual/organization (e.g., with a laboratory offering services to the health care organization), creation of the contract, reviewing the contract, approving the contract, signing the contract, and/or amending the contract may be considered as events. In various embodiments, when the health care organization associates itself with another health care provider, digitally creating the health care provider profile, importing the provider profile, reconciling the provider profile with the system, and/or changing the provider profile may also be considered as exemplary events. As would be readily understood, various other types of events may also be envisioned.

In various embodiments, when an event occurs, the associated procedure may initiate a “workorder,” which may broadly refer to all the activities of the procedure. Some of the activities of the workorder may be assigned to and may have to be performed by one or more resource(s) (e.g., one or more user(s) of the system 10, a department in the health care organization or other personnel in the organization, a component of the system 10, etc.), which may broadly be referred to as “tasks” associated with a workorder or a procedure. That is, a task may broadly refer to the activities of a workorder/procedure allocated to one or more resource(s), which the resource(s) may perform till completion.

In various embodiments, the system 10 may include rules 30, which may be used during the design phase 20 and/or the execution phase 50. A user of the system 10 may generate some of the rules 30 during the design and/or the execution phases 20 and 50, respectively; some rules may inherently be built in the system 10. The rules 30 may include form rules 32, which may define various rules associated with one or more form elements. In various embodiments, the form rules 32 may be a combination of a form condition and a form instruction that takes a canonical form. For example, a form rule may state that if a form condition associated with a form field is X, then issue form instruction Y, else issue form instruction Z.

In various embodiments, the rules 30 may also include activity rules 34, which may define rule(s) for one or more activities associated with a procedure. In various embodiments, the rules 30 may also include system rules 36. In various embodiments, the system rules 36 may specify one or more action(s) taken by the system 10 and/or its component(s) (system activity) in response to another activity or a form condition. For example, a system rule 36 may specify that if form condition(s) associated with a form field is A, then the system should take step B, else step C.

In various embodiments, the rules 30 may also include activity transition rules 40. As previously discussed, in various embodiments, a procedure may broadly refer to a sequence of activities, where one activity may become relevant after completion of a previous activity. In various embodiments, the term “activity transition” may refer to a transition to a next activity upon completion of a current activity. In various embodiments, an activity transition rule 40 may use an “if”-“then” rule (or any other appropriate rules) to define a transition of activity. For example, an activity transition rule 40 may take the canonical form of: on current activity completion: if condition(s) J are satisfied, then start new activity K, else start new activity L.

In various embodiments, the rules 30 may also include other types of rules. For example, the rules 30 may include visibility rules (not illustrated) that may restrict visibility of certain form elements from certain class of users during the execution phase 50. For example, a financial analyst of the organization may be allowed to access/amend certain financial form elements, while a human resource manager may not be allowed access these form elements.

In various embodiments, the system 10 may also include a workflow studio 26, which may act as a visual workspace where a user may define an event and an associated procedure, activities, tasks, rules, etc. The workflow studio may also provide the user with an interface to define data control flow, visibility rules, and/or resource allocation. In various embodiments, the workflow studio 26 may be associated with a procedure library 28 that may allow a user to inspect and edit a current library of defined procedure(s).

In various embodiments, the system 10 may also include an activity manager 52, which may translate activities of a procedure into tasks of a workorder. In various embodiments, the activity manager 52 may incorporate a visual workspace where a user may see her task queues and interact with these tasks and associated forms, and/or complete the tasks.

In various embodiments, the system 10 may also include a task dispatcher 54, which may dispatch a task to a resource to whom the task has been assigned. In various embodiments, a task may be assigned to an individual user or to a group of users (group task) that any member of the group may complete. In various embodiments, the system 10 may also include an administration and policy management component 42, which may include various administrative rules and policies related to the system.

In various embodiments, the system 10 may interact with various other outside components. For example, as illustrated in FIG. 1, an event manager 60 may interact with system 10 during the design phase 20 and/or the execution phase 50. In various embodiments, an event manager may, for example, keep track of one or more event(s), communicate the same to the system 10, receive event completion information from the system 10, etc.

In various embodiments, the system 10 may also interact with a contract manager 62. The contract manager 62 may, in various embodiments, generate and manage contracts the health care organization has with other health care organizations, health service providers, health insurance providers, laboratories, physicians, and/or other individuals. For example, the health care organization may be engaged in a contract with a laboratory which provides radiology services to the health care organization, with a physician associated with the organization, and/or with a health insurance provider whom the health care organization bills regularly. In various embodiments, Choreo™ Contract Manager® provided by Kryptiq, located at Hillsboro, Oreg., may operate as the contract manager 62. In various embodiments, the system 10 may also interact with a report visualizer 64 used to visualize and display one or more report(s) generated by the system 10. In various embodiments, the system 10 may also interact with a resource manager 68 used to manage one or more resource(s). For example, the resource manager 68 may maintain a list of active resources and/or a queue of tasks pending with each resource.

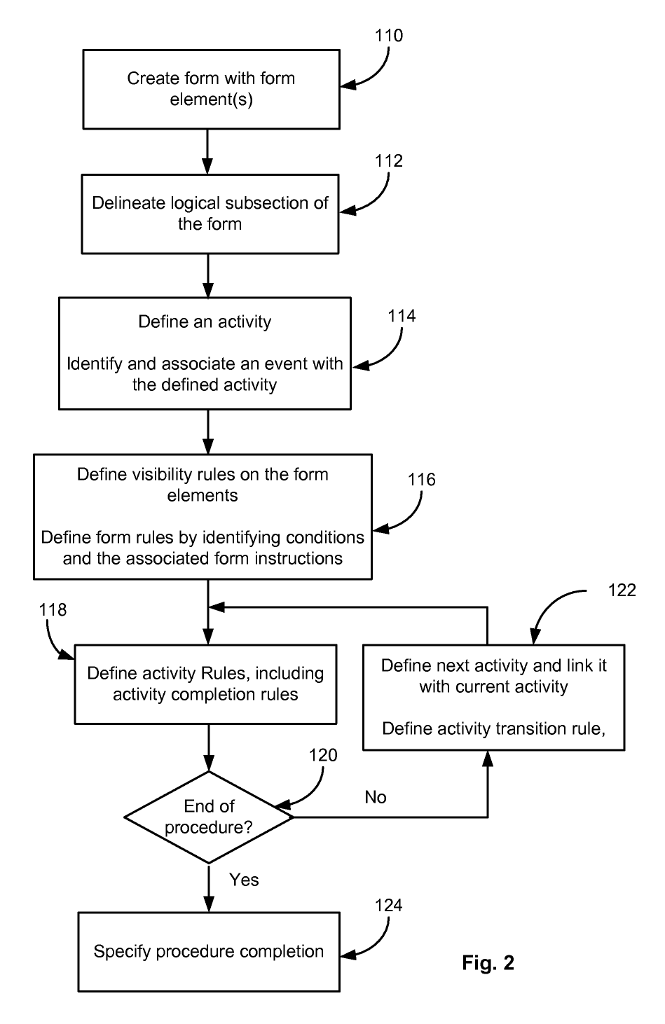

FIG. 2 is an exemplary flow diagram illustrating a method for the design phase 20 of the system 10 of FIG. 1 in accordance with various embodiments of the invention. During the design phase 20, the system 10, or its user, may design, create, or define one or more form(s), activities, procedures, tasks, workorders, rules, etc. associated with an event, thereby defining and standardizing a workflow for the event. During the execution phase 50, with the occurrence of that event, the system may execute the associated workflow. For example, during the design phase 20, the system 10 may define and standardize a workflow associated with an exemplary event of entering into a contract with outside laboratories. During the execution phase 50, if the health care organization agrees to enter into a contract with laboratory X, the system 10 will execute the standardized workflow associated with the event by executing associated procedure(s), tasks and workorders, thereby smoothly completing the event of entering into the contract with laboratory X.

Referring to FIGS. 1 and 2, in various embodiments, during the design phase 20, the system 10 or its user may, at 110, create one or more forms having one or more form elements. The form manager 22 may be used to create the form(s) and optionally save the form(s) in the form library 24. In various embodiments, a user of the system 10 may also upload forms created by a third party application, and/or edit a third party form. In various embodiments, when the form(s) are created in connection with an event, the form elements may be created in view of information received about the event from the event manager 60 and/or contract manager 62.

In various embodiments, at 112, the user may delineate one or more logical subsections in the created form. For example, if the form is created to enter into a new contract with outside laboratories, financial information of the laboratories in the form may be delineated as a logical subsection, human resource information in the form may be delineated as another logical subsection, and the service rates may be delineated as yet another logical subsection.

In various embodiments, at 114, the user may define an activity by associating the form(s) with a resource. The activity may be associated with an event. In various embodiments, identifying the event may start the process of building an associated procedure, which, in various embodiments, may broadly refer to a sequence of activities.

In various embodiments, at 116, access to certain logical subsection(s) of the forms may be restricted to certain resource(s), defined by the visibility rules previously discussed. For example, during the execution phase 50, employees of human resource department of the health care organization may not be given access to a financial subsection of the form. The user may also define, at 116, various form conditions and form instructions associated with various form fields, thereby defining form rules 32.

In various embodiments, once the first activity has been defined at 114 and associated with an event (e.g., a new contract with outside laboratories), the user may at 118 define activity rules 34, including activity completion rules associated with the activity. An example of activity related to the exemplary event of a new contract may be completing, during the execution phase 50, financial information of the outside laboratory in a form. In the design phase 20, various attributes and form elements related to this activity may be created and/or defined at 118 in the form created at 110.

In various embodiments, at 120, the user may check if the procedure associated with the event has been completely defined (i.e., has ended), by determining if all activities associated with an event have been defined. If one or more activities remain to be defined, the user may define the next activity at 122, and link it with the current activity by defining activity transition rules 40. The cycle may continue until all activities in the procedure of the event have been defined (procedure completion at 124).

In various embodiments, the system 10 may use Extensible Markup Language (XML) or other appropriate techniques to generate/define forms, activities, procedures, and/or associated rules.

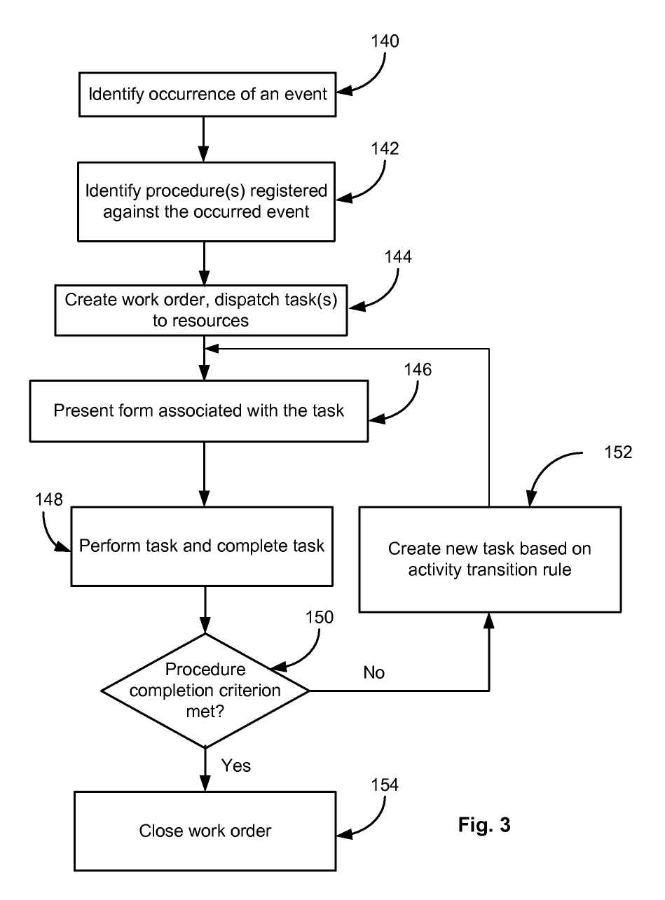

FIG. 3 is an exemplary flow diagram illustrating a method for the execution phase 50 of the system 10 of FIG. 1 in accordance with various embodiments of the invention. As previously discussed, in the design phase 20 (FIG. 2), the system may define and standardize workflow associated with an event. During the execution phase 50, with the occurrence of that event, the system may execute the workflow. Referring to FIGS. 1 and 3, in various embodiments, at 140, the system 10 may identify an occurrence of an event (workflow of which may have been previously defined in the design phase 20). For example, the health care organization may decide to enter into a new contract with XYZ laboratory.

At 142, the system 10 may identify procedure(s) registered against the event. For example, the activity manager 52 may identify the sequence of activities associated with the event(s) that were defined earlier in the design phase 20. In various embodiments, at 144, the system 10 may create one or more workorders for the procedure(s) associated with the event. The workorder may include one or more activities to be assigned as tasks to one or more resources. At 144, one or more activities from the workorder associated with the event may then be dispatched as tasks by the task dispatcher 54 to one or more respective resources to which the task(s) are assigned. The dispatched task(s) may be queued in one or more task queues corresponding to one or more resources, and the assigned resource may be notified about the pending task(s). In various embodiments, the system 10 may include a visual workspace where a resource may inspect the assigned tasks in the task queue.

Upon the resource choosing to work on the dispatched task(s), the resource may be presented with one or more form(s) associated with the task at 146. The resource may perform the assigned task(s) at 148 by, for example, performing one or more form actions, and the corresponding form rules may be executed. In various embodiments, form actions may involve dealing with various form elements (e.g., changing a value of a form field). In various embodiments, one or more form actions may partly be completed, manually and/or automatically, using information received from, for example, contract manager 62 and/or event manager 60.

Upon meeting the activity completion criteria at 148, the system 10 may verify if the procedure completion criterion has been met at 150. The procedure completion criterion may be met if all activities in the procedure are completed. If one or more tasks are pending (i.e., No at 150), new task(s) may be created at 152 based on activity transition rules 40. The cycle may continue until the procedure is completed, upon which the workorder may be closed at 154. This would imply completion of all necessary activities related to the event (e.g., completing all activities related to the new contract with the XYZ laboratory).

In various embodiments, in the health care organization, there may be two types of users using the system 10. For example, a first type of user (e.g., business analysts, system administrators, etc.) may be involved primarily during the design phase 20, and a second type of user (e.g., financial analysts, contract manager, director of medical economics, etc.) may use the system during the execution phase 50. As would be apparent, such a classification is not rigid, and a user of one type may act as a user of the other type.

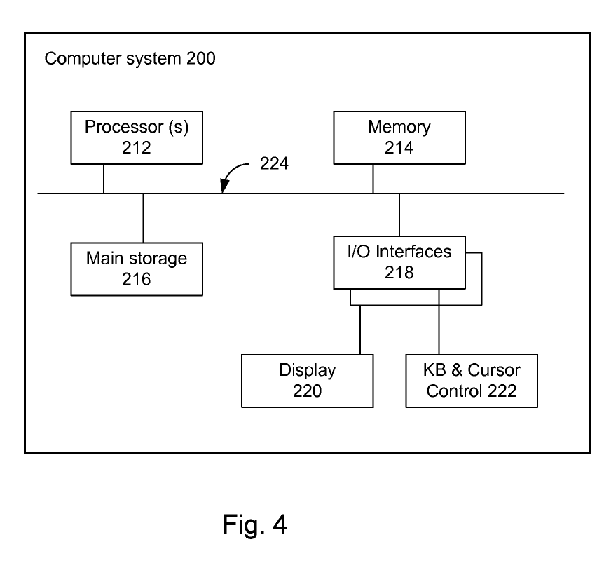

FIG. 4 is an exemplary block diagram illustrating a computer system 200 that may be suitable for practicing the health care administration system 10 of FIG. 1 in accordance with various embodiments of the present invention. As illustrated, the computer system 200 includes one or more digital computing processor(s) 212 and memory 214 coupled to each other via bus 224. Further, computer system 200 includes mass storage device 216, I/O interfaces 218, and a number of I/O devices coupled to each other and the earlier described elements as shown. In various embodiments, memory 214 and/or mass storage device 216 may include some or all the components of the system 10. In various embodiments, some of the components of the system 10 may also be included in a different computer system, accessible to the computer system 200. In various embodiments, I/O interfaces 218 include a communication interface for coupling the computer system 200 to other computer systems in which some of the components of the health care administration system 10 may be included. The communication interface may be wire based or wireless, used to couple the computer system 200 to a network, e.g. a wired/wireless local/wide area network. An example of a suitable wired network interface includes, but is not limited to, an Ethernet interface, and an example of a suitable wireless network interface includes, but is not limited to, an IEEE 802.11b (working group) network interface. The I/O devices include in particular, display 220 and keyboard/cursor control 222.

In various embodiments, processor 212 may be any one of a number of microprocessors known in the art, or to be designed (as long as they are consistent with the teachings of the present invention), including but not limited to, the processors available from Intel Corp.®, of Santa Clara, Calif. Memory 214 may likewise be any one of a number of volatile storage known in the art or to be designed (as long as they are consistent with the teachings of the present invention), including but not limited to, the volatile storage available from Kingston Technology® of Fountain Valley, Calif. Mass storage device 216 may likewise be any one of a number of non-volatile storage known in the art or to be designed (as long as they are consistent with the teachings of the present invention), including but not limited to, the non-volatile disk storage available from Seagate of Scotts Valley®, Calif.

Each of the elements of this figure represents a broad range of the corresponding element known in the art or to be designed, consistent with the teachings of the present invention. The elements perform their conventional functions, i.e. processing, storing, reading, displaying, and so forth. In various embodiments, the health care administration system 10 may be a single or a plurality of processes, executed as a single thread or multiple threads, on a single or multiple processors.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A method for managing a health care organization, the method comprising:
standardizing, during a design phase, a computerized workflow associated with a health care administration related event, the computerized workflow facilitating a procedure to be completed on occurrence of the health care administration related event; and
executing, during an executing phase, the computerized workflow to complete the procedure associated with the health care administration related event, on occurrence of the health care administration related event.

2. The method of claim 1, wherein standardizing the computerized workflow comprises:
defining for a computerized health care administration application a plurality of activities associated with the health care administration related event.

3. The method of claim 2, further comprising:
defining for the computerized health care administration application a plurality of activity transition rules to govern transition between the plurality of activities.

4. The method of claim 1, wherein said standardizing of the computerized workflow comprises:
generating by a computerized health care administration application at least one form associated with the health care administration related event.

5. The method of claim 4, further comprising:
generating by the computerized health care administration application at least one form condition associated with a form element of the at least one form; and
associating the form condition with a form instruction.

6. The method of claim 2, further comprising:
allocating by the computerized health care administration application one or more of the plurality of activities to a resource in the health care organization.

7. The method of claim 1, further comprising:
defining for a computerized health care administration application, during the design phase, the procedure associated with the health care administration related event.

8. The method of claim 1, wherein said executing of the computerized workflow comprises:
dispatching a task by a computerized health care administration application to a resource of the health care organization.

9. The method of claim 8, further comprising:
the computerized health care administration application facilitating a health care administrator in completing the dispatched task and subsequently selecting a new task based in part on an activity transition rule.

10. The method of claim 8, wherein said standardizing of the computerized workflow further comprises:
presenting by the computerized health care administration application a visual workspace for use by a health care administrator to perform the standardizing of the computerized workflow.

11. A system for managing a health care organization, the system comprising:
one or more storage devices including one or more databases adapted to store data; and
one or more servers operatively coupled to the one or more storage devices, the one or more servers being configured to standardize, during a design phase, a computerized workflow associated with a health care administration related event, the computerized workflow facilitating a procedure to be completed on occurrence of the health care administration related event, and the one or more servers being further configured to execute, during an executing phase, the computerized workflow to complete the procedure associated with the health care administration related event, on occurrence of the health care administration related event.

12. The system of claim 11, wherein the one or more servers are further configured to facilitate:
defining of a plurality of activities associated with the health care administration related event.

13. The system of claim 12, the one or more servers being further configured to facilitate:
defining of a plurality of activity transition rules to govern transition between the plurality of activities.

14. The system of claim 11, wherein the one or more servers are further configured to:
generate at least one form associated with the health care administration related event;
generate at least one form condition associated with a form element of the at least one form; and
associate the form condition with a form instruction.

15. The system of claim 11, the one or more servers being further configured to:
facilitate a health care administrator in completing a task associated with the health care administration related event and subsequently selecting a new task based in part on an activity transition rule.

16. The system of claim 11, the one or more servers being further configured to:
present a visual workspace for a health care administrator to standardize the computerized workflow.

17. An article of manufacture comprising:
a storage medium; and
a plurality of instructions stored therein;
wherein the plurality of instructions are adapted to cause one or more processors to perform a plurality of health care event management operations, the plurality of operations comprising:
facilitating a health care administrator in standardizing, during a design phase, a computerized workflow associated with a health care administration related event, the computerized workflow performing a procedure to be completed on occurrence of a health care administration related event; and
executing, during an executing phase, the computerized workflow to complete the procedure associated with the health care administration related event on occurrence of the health care administration related event.

18. The article of manufacture of claim 17, the plurality of operations further comprising:
facilitating a health care administrator in defining a plurality of activities associated with the health care administration related event; and
facilitating a health care administrator in defining a plurality of activity transition rules to govern transition between the plurality of activities.

19. The article of manufacture of claim 17, the plurality of operations further comprising:
generating, during the design phase, at least one form associated with the health care administration related event.
generating at least one form condition associated with a form element of the at least one form; and
associating the form condition with a form instruction.

20. The article of manufacture of claim 17, the plurality of operations further comprising:
dispatching a task to a resource of the health care organization; and
facilitating a health care administrator in completing the dispatched task and subsequently selecting a new task based in part on an activity transition rule.
